(19) United States
(12) Patent Application Publication
(10) Pub. No.: US 2026/0241642 A1
(43) Pub. Date: Aug. 20, 2026

(54) IN-SITU CLASSIFICATION OF DEFECTS IN MATERIAL EXTRUSION

(71) Applicant: Georgia Southern University Research and Service Foundation, Inc., Statesboro, GA (US)

(72) Inventors: Hossain Ahmed, Statesboro, GA (US); Asef Ishraq Sadaf, Statesboro, GA (US)

(21) Appl. No.: 19/544,410

(22) Filed: Feb. 19, 2026

Related U.S. Application Data
(60) Provisional application No. 63/760,422, filed on Feb. 19, 2025.

(51) Int. Cl. B29C 64/393; B29C 64/118; B33Y 50/02; G05B 13/02

(52) U.S. Cl. CPC B29C 64/393; B29C 64/118; B33Y 50/02; G05B 13/027

(57) ABSTRACT

Disclosed herein are systems and methods for an infrared (IR) thermography-based framework for continuous data acquisition and processing to distinguish between various levels of defects in additive manufacturing (AM), and in particular material extrusion (ME).

### CROSS-REFERENCE TO RELATED APPLICATION

This application claims priority to and benefit of U.S. Provisional Patent Application Ser. No. 63/760,422 filed Feb. 19, 2025, which is fully incorporated by reference and made a part hereof.

### FIELD

Described herein are systems and methods for overcoming process reliability challenges in material extrusion (ME), a prominent additive manufacturing (AM) technique.

### BACKGROUND

ME is a widely used AM technique, known for its versatility, cost-effectiveness, and ability to produce complex parts on-demand with greater customization and reduced waste. However, the process is impeded by unpredictable factors causing defects such as voids, overextrusions, and underextrusions, which may result in part quality variances due to uncontrollable factors. Other challenges in conventional ME may also include no established non-destructive real-time monitoring method for efficient integration in closed-loop control; post-production inspection is time-consuming and cannot prevent mid-print failures; changes in process deviation results in underextrusion or overextrusion; and loss of material, time, money, and overall efficiency caused by defects and scrapping defective products.

Currently, the ME process is monitored manually where a human operator stops and restarts the entire printing process if severe underextrusion is observed, which results in substantial wastage of material, machine operating time, and human working hours. Since manual inspection is only useful if the process deviation is noticeable by bare human eyes, it limits the detection of subtle defects in the critical locations which may have a major impact on the final part performance. Although post-processing techniques exist with a primary focus of improving the surface finish and appearance, these techniques have limitations to eliminate defect propagation that has already been induced in the printed structure. Additionally, the lack of real-time quantitative measurement of the extent of the process deviation acts as a major obstruction to setting up closed-loop control systems capable of producing first-time-ready parts. Thus, developing a framework for automated monitoring of the printing process is necessary so that a real-time corrective measure can be taken to consistently print parts within a tolerable dimension range. As an initial step to establish a robust control system, researchers have been proposing various strategies to monitor the printing process utilizing a wide array of sensors. The collection of data from these sensors can be based on optical imagery, acoustic responses, mechanical vibrations, electrical current, surface temperature, etc. The challenges in such data-driven approaches include acquisition and efficient processing of large volumes data for inference in real-time. Therefore, researchers have combined traditional and data-driven techniques to speed up data acquisition and processing. Compared to other sensors, the implementation of cameras, whether be it optical or thermal, results in a greater amount of data acquisition which could be beneficial in quickly inferring defects in in-printing parts. However, previous experimental approaches for defect detection using camera-based approaches can hardly detect defects in a short amount of time. Stationary camera systems have been utilized making the evaluation of real-time thermal profile of each layer inherently complex. In some instances, the print process itself has been interrupted for acquisition of optical data which may potentially turn into a source of inducing potential defect. Moreover, only utilizing an optical camera can merely detect defects rapidly due to the inherent nonequilibrium thermodynamic process involved in ME. This includes temperature fluctuations during the formation of bonds between printed layers. In this respect, real-time measurement of the temperature profile of the in-printing parts can be a viable option, where non-invasive techniques such as integration of IR camera serves as an optimal solution. Conventionally, there have been limited attempts to profile the temperature evolution in the ME process. In one instance, the temperatures in two distinct 3D printers incorporating significantly different filament sizes were examined using an IR camera during the extrusion process. The study found a direct relationship between the extruded bead diameter and the cooling duration of the deposited layer. In another instance, it was reported that even temperature distribution enhances the mechanical qualities of the created parts while studying the thermal changes during the ME process. This instance also noted the significant impact of ambient temperature, infill density, and infill scan pattern on heat transfer between building layers. Additionally, studies have been done to propose calibration and noise reduction techniques for thermal data acquisition. For example, Lewis et al. [23] implemented a dual IR temperature sensor approach and formulated a statistical technique to identify purposefully created defects within the ME process. The system demonstrated the ability to detect voids with a minimum width of 1.5 mm and suggested that smaller defects might not be identified. Although the investigation employed basic statistical methods to classify between underextrusion, pristine, and overextrusion print conditions, the methodology did not provide any information about the severity of the process deviation. While these efforts offer a multitude of approaches for validating analytical and numerical models and investigating temperature distribution, there is no established framework for in-situ monitoring of process deviations or estimating deviation severity in ME processes using infrared thermography.

Therefore, system and methods are needed to overcome challenges in the art, some of which are described above.

### SUMMARY

Because of the challenges described above, real-time in-situ, detection of defects and feedback control is a more appropriate method for achieving consistent manufacturing results. Described herein is real-time in-situ control methods and systems as well as results from initial testing.

More specifically, in-situ data acquisition, data processing and analysis methods and systems are described herein utilizing thermal data collection without disrupting the ME process. For data acquisition, a design and implementation of an exemplary experimental setup and a custom data acquisition from infrared camera have been demonstrated. The acquired thermal data are then passed through several signal processing techniques along with explanation of the thermal signal characteristics. Lastly, the processed data are analyzed using two independent methods: the correlation matrix and feature extraction. The analysis through feature extraction of the thermal signature allows the classification of various levels of underextrusions. By employing the disclosed systems and methods, it has been demonstrated that the onset of underextrusion can be detected in less than five seconds of defect onset by analyzing the thermal signature within a relatively small spatiotemporal region. The experimental procedure including experimental setup, design of experiment, data acquisition, and data filtering are described herein. The data analysis process and the results describing the potential of the framework to be integrated into real-time condition monitoring are further described herein.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The accompanying drawings, which are incorporated in and constitute a part of this specification, illustrate embodiments and together with the description, serve to explain the principles of the methods and systems. [[COLOR DRAWINGS]]

FIG. 1 illustrates an exemplary overview of a system for integration of infrared (IR) thermography and deep learning for real-time in-situ defect detection and rapid elimination of defect propagation in additive manufacturing, in particular material extrusion.

FIG. 2A illustrates an example of a training procedure for an instance of a deep learning model.

FIG. 2B illustrates an application of the well-trained deep learning model to an instance in real-time and in-situ ME process to monitor and adjust the relative flow rate (RFR) based on the predicted RFR from the well-trained deep learning model.

FIGS. 3A and 3B illustrate examples of experimental setups featuring extended platforms and IR cameras. FIG. 3A illustrates an isometric view of a setup with an exemplary extended platform, while FIG. 3B illustrates a portion of an exemplary IR camera's point of view observing the extrusion process.

FIG. 3C illustrates an exemplary ME process device according to embodiments described herein.

FIG. 3D illustrates an exemplary custom-designed extended platform, which is attached to the ME process device and an IR camera is attached to the extended platform.

FIG. 3E illustrates a complete exemplary experimental setup showing that the extrusion nozzle has three-dimensional (3-D) movement capabilities over the print bed or print zone while the IR camera mounted on the extended platform captures images of the ME process.

FIGS. 4A and 4B illustrate modification of extrusion amount in the G-code to induce underextruded surface (FIG. 4A), and layers induced with underextrusion (FIG. 4B).

FIG. 5 shows one sample from each group of 25%, 50%, 75%, and 100% extrusion levels at specified layers.

FIG. 6 is an image of the material extrusion process observed in FLIR Research Studio software.

FIG. 7 illustrates that thermal data for 15 specific vertical points that were acquired to observe the thermal signature of different layers.

FIG. 8 illustrates a temporal profile of the temperature plotted for the selected points.

FIGS. 9A-9C illustrate time series data before subtraction of initial background data (FIG. 9A), close up view of data to be removed (FIG. 9B), and time series data after subtraction of initial background data (FIG. 9C).

FIGS. 10A-10B illustrate an application of sliding rms to remove artifact generated by nozzle, where FIG. 10A shows sliding rms over one point and applying threshold to find the last time index where rms exceeds threshold, and FIG. 10B shows sliding rms over multiple points where the threshold value is gradually increased.

FIGS. 11A-11C show temporal data for a pristine sample after nozzle artifact has been removed (FIG. 11A), temporal data for a single point before removal of nozzle artifact (FIG. 11B), and temporal data for a single point after removal of nozzle artifact (FIG. 11C).

FIG. 12 is an exemplary flowchart for the overall methodology of the experimental setup.

FIG. 13 is a graph showing 5 seconds of initial temperature signature for the starting point of intentional defect of one sample from each group.

FIG. 14 is an example of a correlation matrix of selected temporal data for all G-coded modified samples.

FIG. 15 is an illustration of a temperature profile of different G-code modified groups where the solid line indicates the mean temperature values of different samples, and the band indicates the standard deviation.

FIGS. 16A-16C are exemplary illustrations of minimum temperature vs G-code modified groups (FIG. 16A), maximum temperature vs G-code modified groups (FIG. 16B), and maximum temperature vs minimum temperature (FIG. 16C).

FIG. 17 is a block diagram of an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where the feature, event or circumstance occurs and instances where it does not. While implementations will be described for providing real-time control of ME processes, it will become evident to those skilled in the art that the implementations are not limited thereto, but are applicable for providing real-time control of other AM processes.

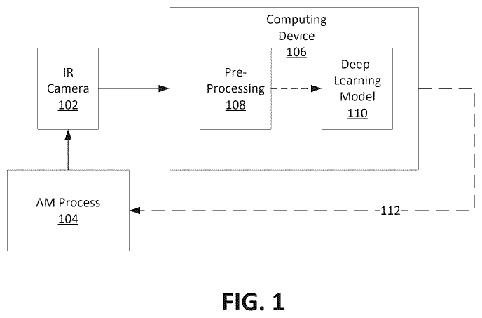

FIG. 1 illustrates an exemplary overview of a system for integration of infrared (IR) thermography and deep learning for real-time in-situ defect detection and rapid elimination of defect propagation in additive manufacturing, in particular material extrusion. As shown in FIG. 1, an IR camera 102 captures images of an on-going additive manufacturing process 104, such as material extrusion. As used herein, “images” includes still images as well as video, including captured frames from a video. The images acquired by the IR camera 102 are provided to a computing device 106. As used herein, “computing device” may refer to a single computing device, or a plurality of computing devices. If a plurality of computing devices, they may be located together or located at disparate locations connected by a network or networks. Furthermore, “computing device” as used herein may refer to cloud computing. The computing device 106 may or may not be local to the IR camera 102. In some instances, the “computing device” 106 may comprise a part of the AM process 104 and/or the IR camera 102. By “providing” the acquired images to the computing device 106, this may be done by transmitting the images over a network, or by storing the images on a physical media and transporting the physical media to the computing device 106 where the images are downloaded, or any other way of receiving the images by the computing device 106. Once the images are received by the computing device 106, they are preprocessed 108 using software executing on the computing device 106, as further described herein. Once pre-processed, the pre-processed images are provided to a trained deep learning model 110. If the trained deep learning model identifies defects, or conditions that could lead to defects from an analysis of the pre-processed images, then a control signal 112 is provided to the AM process 104 to control parameters of the AM process 104 to prevent, correct, or mitigate the defects. Generally. This control is performed in real-time without stopping the AM process 104 so that waste is prevented or minimized from the AM process 104.

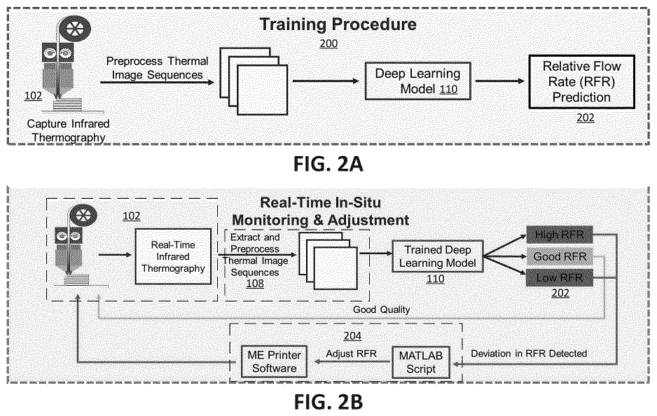

FIG. 2A illustrates an example of a training procedure 200 for an instance of a deep learning model 110. Deep learning models are trained on vast datasets of thermal images correlated with process parameters and outcomes. The models can learn to identify patterns and anomalies that are indicative of process deviations, defects, or equipment malfunctions. In this illustration, infrared images of an exemplary ME process are captured during the extrusion process by the IR camera 102. The images are preprocessed and supplied to the deep learning model 110. Preprocessing may include one or more steps of image cropping, automation of extrusion start and end detection, start of predefined layer detection, sequence trimming, data labeling, data splitting, and data sub-segmentation. One or more of these steps may occur during data acquisition by the IR cameras 102, and one or more of these steps may occur before feeding into the deep learning model 110.

The deep learning model 110 performs an analysis of the preprocessed images and makes a prediction 202 of the relative flow rate (RFR) of the ME process to avoid potential defects, mitigate defects in process, and/or correct defects. As used herein, RFR refers to the rate at which material is fed through the extrusion nozzle of the ME process relative to the speed at which the nozzle is moving. The RFR prediction 202 is then analyzed and based on that analysis, the deep learning model 110 is adjusted. In some instances, the analysis performed on the RFR prediction 202 may be performed manually. In other instances, the analysis may be performed by computer software. The training procedure 200 is repeated for a plurality of processed IR images of a plurality of ME processes using different ME devises/systems and different IR cameras 102 until the deep learning model 110 is well-trained. Various neural networks may be used for the deep learning model including but not limited to convolutional neural networks (CNN), CNN+long short-term memory (LSTM), CNN+SelfAttention, recurrent neural networks (RNN), and the like. Furthermore, among all the explored deep learning models it was found that CNN+SelfAttention performed the best in distinguishing defect severity; however, this disclosure is not limited to that deep learning model nor is it limited to just the deep learning models mentioned herein. Additionally, details about training the deep learning models described herein.

FIG. 2B illustrates an application of the well-trained deep learning model 110 to an instance in real-time and in-situ ME process to monitor and adjust the RFR based on the predicted RFR from the well-trained deep learning model 110. As with the above, an IR camera 102 captures real-time images of an ME process 104, the images are preprocessed 108 and provided to the well-trained deep learning model 110, where a prediction 202 of RFR is made based on the analysis of the preprocessed images by the well-trained deep learning model 110. The predicted RFR is then compared to the actual RFR of the ME process 104, and adjustments 204 are made to the ME process 104 if the actual RFR is higher than the predicted RFR, or if the actual RFR is lower than the predicted RFR. In this way the RFR of the ME process 104 is optimized, and defects are mitigated, all in real-time. In some instances, a MATLAB script receives the predicted RFR and makes adjustments to the ME process 104 using printer software of the ME process 104.

### Experiment

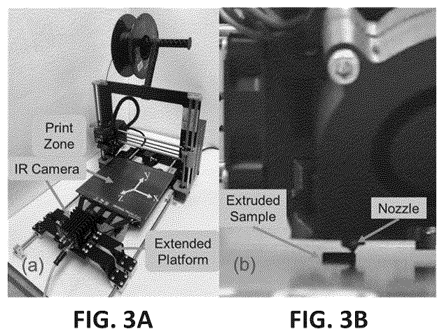

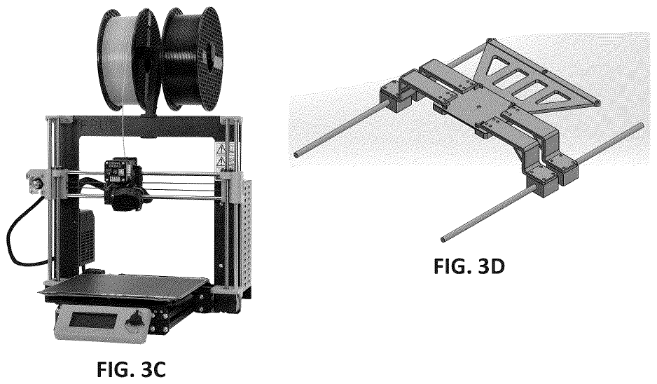

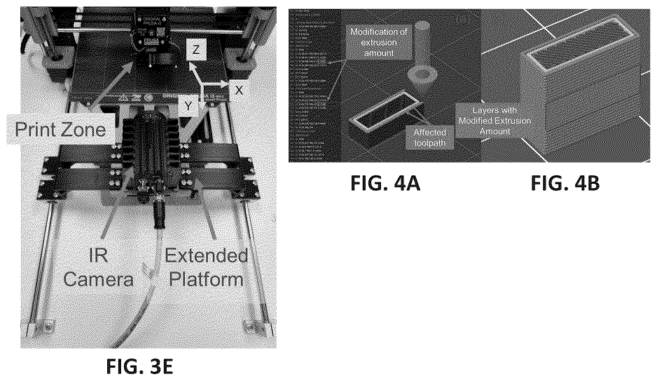

FIGS. 3A and 3B illustrate examples of experimental setups featuring extended platforms and IR cameras. FIG. 3A illustrates an isometric view of a setup with an exemplary extended platform. FIG. 3B illustrates a portion of an exemplary IR camera's point of view observing the extrusion process.

As shown in FIG. 3C, the exemplary experimental setup of FIG. 3B is comprised of an ME process device 302, which includes the extrusion nozzle, the heating device, a build platform (print bed), apparatus for automatically adjusting the location of the extrusion nozzle over the build platform as controlled by software executing on a processor or the device 302, where the software also controls the ME process 104 and can receive and act on external control signals. In the example shown in FIG. 3C, the ME process device 302 comprises a Prusa i3 MK3 (Prusa Research a.s., Prague, Czech Republic), though other commercial as well as custom-built ME process devices are considered within the scope of this disclosure. Further comprising the experimental setup, black Polylactic Acid (PLA) filament, with a diameter of 1.75 mm, produced by a commercial supplier, Hatchbox, is utilized for printing 3D objects. PLA possesses a melting temperature of 175° C. and exhibits a low thermal expansion coefficient, leading to minimal or no warping. While printing, the print bed and the extruder are kept at 60° C. and 215° C. respectively. The default print speed of 80 mm/s is kept constant for printing all the samples.

The experimental setup is further comprised of a custom-designed extended platform 304 (FIG. 3D), which is attached to the ME process device 302 and the IR camera 306 is attached to the extended platform 304. The extended platform 304 allows movement of the IR camera 306 relative to the print bed. In the exemplary setup, the IR camera 306 comprises a FLIR A50 camera having 464×348 pixels optical resolution, and a thermal resolution of <45 mK with an accuracy of ±2° C. (Teledyne Technologies, Wilsonville, OR USA). FIG. 3E illustrates the complete experimental setup showing that the extrusion nozzle has three-dimensional (3-D) movement capabilities over the print bed or print zone while the IR camera 306 mounted on the extended platform 304 captures images of the ME process. It is to be appreciated that other devices and methods of acquiring IR images of the ME process are contemplated within the scope of this disclosure.

For the experimental setup, the geometry of the extruded workpiece considered as the pristine sample in this study is a simple rectangular block with a length of 10 mm, width of 4 mm, and height of 9 mm. The workpiece is designed in SolidWorks, exported as Standard Tessellation Language (STL) files, and converted to G-code by slicing the STL file in PrusaSlicer 2.5.1. While slicing, the printing profile settings are modified as shown in Table 1. Additionally, the skirt and brims are removed to provide better visibility starting from the base layer. The resulting workpiece geometries each have 30 layers.

TABLE 1
Printing Profile Settings

| Printing parameter | Value |
|---|---|
| Layer height | 0.3 mm |
| Infill density | 20% |
| Infill pattern | Aligned |
| | Rectilinear |
| Number of solid | 3 |
| horizontal layers on the top | |
| Number of solid | 3 |
| horizontal layers on the bottom | |
| Print Speed | Machine |
| | Default |

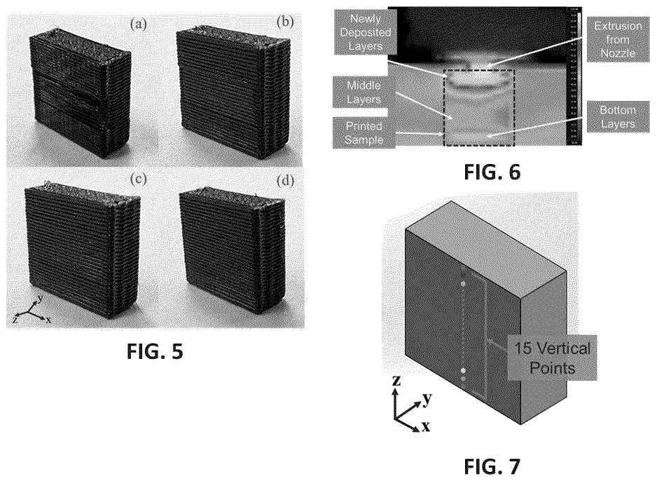

To test the experimental system, the G-code is modified to intentionally introduce underextrusions of various magnitudes. The G-code contains detailed instructions telling the printer when, where, and how to move its nozzle and the build plate. Additionally, the code also dictates factors like layer height, print speed, and extrusion rate. In this study, the G-code is modified in such a manner so that for certain toolpaths, the modified amount of extrusion is a multiplier of the original value, producing samples of four different groups of 25%, 50%, 75%, and 100% extrusion. 100% extrusion implies pristine samples, and the others indicate underextrusion of different levels. The toolpaths affected by this modification start from 3 mm from the base layer and stop at 6 mm from the base thus affecting 11 layers. Only the first two front-facing toolpaths are modified as illustrated in FIGS. 4A and 4B, which show the modification of extrusion amount in the G-code to induce underextruded surface; and layers induced with underextrusion, respectively. One sample from each group of 25%, 50%, 75%, and 100% extrusion levels at specified layers are shown in FIG. 5.

During the entire print duration, continuous thermal data are captured using the IR camera. The IR camera used for this experiment has an infrared sensor with a resolution of 464×348 pixels, the field of view of the lens is 95°, and it offers a thermal resolution of less than 45 mK. Depending on the ambient temperature fluctuations, it can record thermal data with an accuracy of ±2° C. The emissivity of the printed surface has been selected to be 0.92 based on PLA material. Before starting thermal data acquisition, calibration for both the printer and the thermography camera was performed for each sample and then the thermal distribution is recorded at a rate of 30 Hz for ~285 seconds. The thermal distribution of the front surface is illustrated in FIG. 6 as observed in the FLIR Research Studio application, where the high-temperature filament extrusion coming out of the nozzle to form the top layer can be visibly seen. Due to the deposition of hot filament, the top layer shows the highest temperature as a mixture of white and red. The temperature gradient gradually shows a decreasing trend for the previously built layers as the color of the region goes from red to green and green to blue. However, the temperatures of the bottom layers maintain a comparatively higher temperature than the middle layers as shown by the green patch at the bottom. The observation can be simply attributed to the heated build plate which is kept at a constant 60° C. during printing.

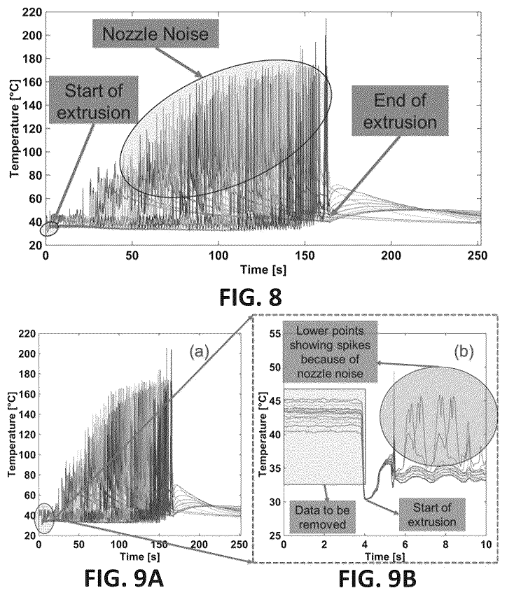

The number of pixels covering the full sample are respectively 16 and 15 in the horizontal and vertical directions making a total of 256 pixels. The number of points depends on the size of the printed object, the distance of the printed object from the camera and the resolution of the camera. At the preset distance of 15 cm between the camera and the front surface of the sample (90 mm²), each of the pixels captured by the IR camera roughly provides thermal data of 0.35 mm² area. In this study, thermal data for 15 specific vertical points are acquired to observe the thermal signature of different layers as depicted in FIG. 7. These 15 points represent the maximum number of vertical measurement points available for the constructed setup and object size. Depending on the available resolution of an IR camera, considering a higher number of points would result in better data acquisition and more thermographic information. On the other hand, a lower number of target points may not be effective in retrieving the necessary information about process monitoring. A MATLAB script was developed to acquire thermal data of these points located at the center of different layers of the sample for ~285 seconds as illustrated in FIG. 8. As the thermal data of 15 vertical points are captured for the 30 consecutive layers building 9 mm of sample height in Z direction, the thermal signature from each point gives the average temperature data for 2 layers. The data acquisition is started manually after the printer finishes its calibration. When the extruder moves to the point of the print location, it is marked by a sudden fall in temperature. This fall marks the start of the printing as shown in FIG. 8. It can be easily noticeable how the high temperature from the nozzle creates significant noise in the point data. The process of eliminating these noises is addressed in the signal filtering process. The print process itself runs for around ~180 seconds, after which the extruder and the fan moves away. This results in a reduced cooling rate, and thus the temperature of the bottom layers rises for a short time before it starts to cool again.

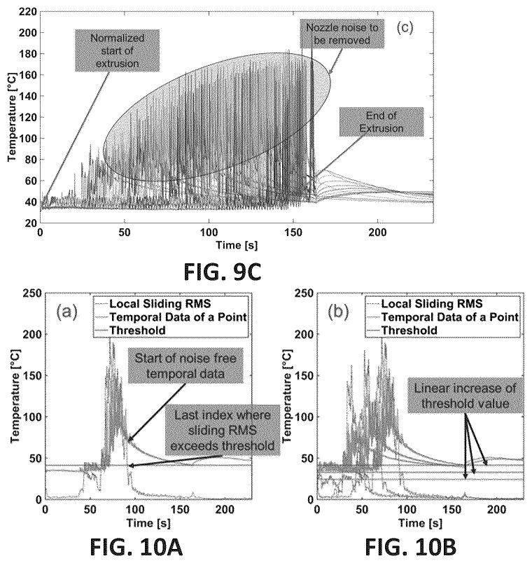

At the start of thermal data acquisition, the extruder places itself in its initial position in the front left corner of the build plate. During this time, the point data captured by the IR camera is the thermal data of the background of the printer which has no relevance to the analysis. It's also desired that the temporal start point is consistent across different data points to avoid any time-related discrepancies. The starting point can be marked by a drop in temperature at the beginning when the extruder first moves near the build zone. To find this point, the lowest temperature values in the initial 6 seconds are first identified for each point. Then the maximum time index is located among these values, and a total of ~233 seconds of temporal data is saved starting from that maximum index for each point for further analysis as illustrated in FIGS. 9A-9C. This timeframe is selected as it is repeatedly observed that around ~220 seconds, the different layers reach equilibrium with each other.

The next step in filtering is to eliminate the noise from the nozzle as it is highly unpredictable. These artifacts form when the nozzle prints near the selected point, either printing in the same layer or the subsequent layers. To solve these issues, first the sliding RMS of each vertical point over the entire duration for all the samples is calculated with a window size of 1% as defined by equation). Here, x[i] is the data point at index ‘i’, W is the window size, and RMS [n] is the RMS value computed at position ‘n’. This window size ensures a proper balance between filtering redundant noise and preserving actual data and is determined heuristically. After that, the last time index for which the RMS value exceeds a predefined threshold is recorded as depicted in IG. 10A. This threshold value is linearly increased for consecutive vertical points as can be seen in Error! Reference source not found. FIG. 10B. Then the maximum values of the time index for all the vertical points of all the samples are recorded. After the completion of this procedure, one array of 15 indexes is found, where these indexes mark the start of the noise-free temperature profile for the selected vertical points of G-code modified samples.

$$RMS [ n ] = \sqrt{\frac{1}{W} {\sum }_{i = n - W + 1}^{n} {x [ i ]}^{2}} \qquad ( 1 )$$

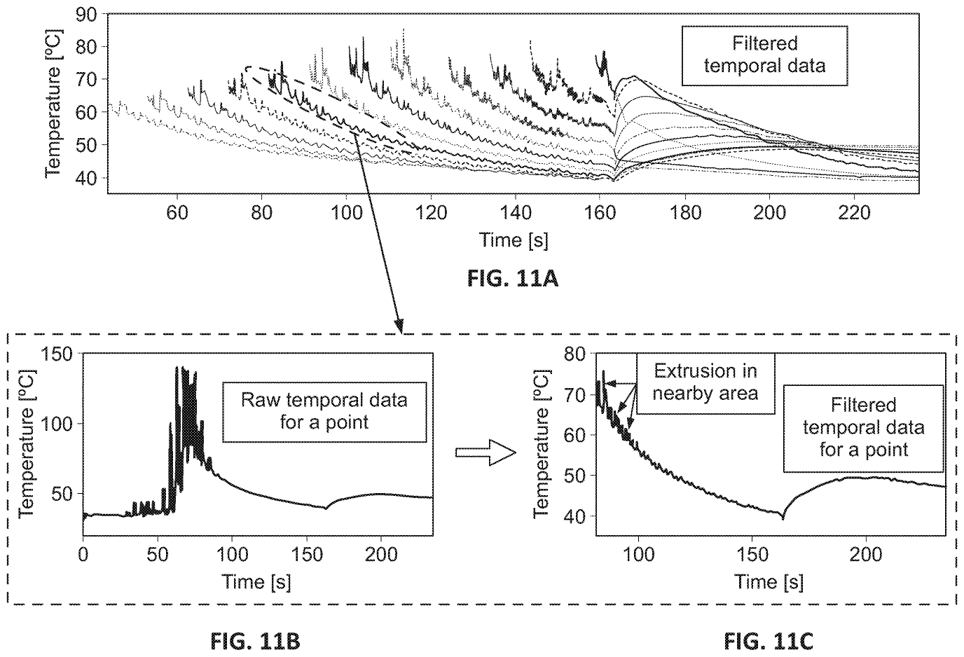

In FIG. 11A, the temporal data after completion of the filtering process for a single sample can be seen for 15 vertical points. The starts of consecutive points have differences in the initial start times as ME process involves layer by layer printing on top of the previous layer. In FIG. 11B, the temporal data of a vertical point has been plotted which contains a lot of nozzle noise, wherever, in FIG. 11C, the temporal data for the same vertical point doesn't contain any noise after the filtering process has been completed. At the beginning of the time series data, a few sharp rises can be observed which are due to the extrusion process in the nearby area. The point data selected for this illustration is in the middle of the sample containing averaged temperature information of layers 9 and 10. The temperature can be seen gradually dropping until the end of the extrusion process after which the fan moves away, and the temperature increases for a short time (after ^{~}170 seconds) before going down again. This method of noise removal is integrated to the data preprocessing algorithm which makes the foundation of in-situ real-time defect detection.

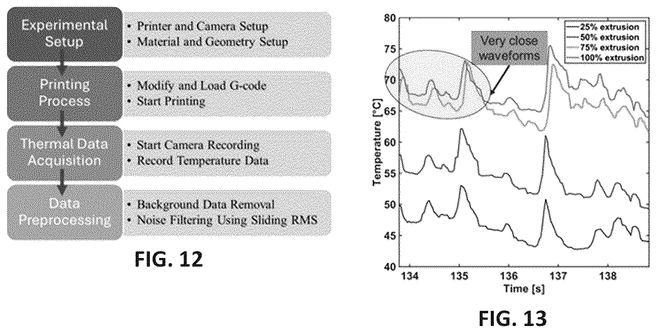

To summarize, a custom platform is designed and attached with the ME printer to hold a thermographic camera, keeping the front surface of the printed object at a fixed distance from the camera. The G-code is modified to induce underextrusion at 25%, 50%, and 75% levels for specific layers, while pristine samples are printed at 100% extrusion. The thermal data from 15 vertical points on the sample are recorded using the camera during the printing process. After that, initial background data is removed, and nozzle-related noise is filtered using a sliding RMS method to extract thermal profiles for further analysis. The methodology is also illustrated in FIG. 12.

### Experimental Results

As the temperature data from each of the 15 points are preprocessed to exclude nozzle noise, the optimal thermal data are explored in-depth to extract the temporal characteristics of the defect-induced layers across the G-code modified samples. In this results section, the detection and classification of various underextrusions are discussed in two subsections, defect detection and defect classification, as follows.

### Defect Detection

In material extrusion processes, detecting defects within in a shortest possible time is a desired performance indicator to minimize material waste, cost, and operational duration. As can be observed in FIG. 11A, the temporal duration of data across the 15 points varies depending on their vertical position in the printed sample. As these points ascend vertically, their temporal duration of thermal data diminishes. For the sample selected for illustration, these durations can range from 10 seconds to more than 120 seconds. However, it is desired to precisely determine whether a part is defective or not within the shortest possible time. For this reason, 5 seconds of initial temporal data for each point is considered for real-time data analysis while the printing is still going on. The selection of this time window of 5 seconds provides a balance between gathering sufficient information for analysis while not letting the propagation of defect go on for too long. The defect in the G-code modified samples starts from layer 9, whose thermal data can be observed in the 5th point from the base for those samples. In FIG. 13, the thermal data over time for the selected point can be seen for one sample from each group of G-code modified samples: 25%, 50%, 75%, and 100% extrusion. It can be observed as a general trend that as the extrusion volume decreases, the average temperature decreases as well. Although the data for 25% and 50% extrusion are distinguishable from other groups, the data for 75% and 100% extrusion have similar waveform in comparison to each other.

### Defect Classification

Beyond mere defect detection, quantifying the defect magnitude is desired for integrating the online monitoring system with a closed-loop control system. This integration enables real-time defect rectification, facilitating the production of first-time print-ready parts. To accomplish this objective, two methodologies are followed in this study. In the first one, below, the application and constraint of correlation matrix has been addressed. Consequently, the second methodology delves into the use of feature extraction for categorizing between pre-established extrusion levels. This dual-approach strategy enhances the precision and efficacy of the defect quantification process in material extrusions.

### Correlation Matrix

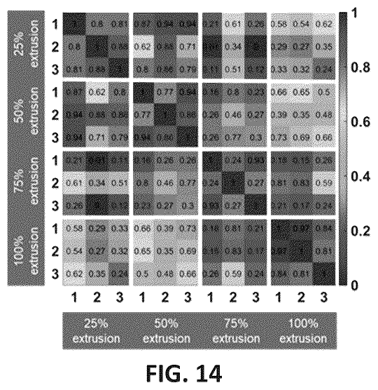

A correlation matrix is developed by utilizing the nozzle noise free temporal thermal data of all sample groups. A correlation matrix is a table that represents the correlation coefficients between multiple signals or variables and provides an overview of the relationships within the dataset. Each entry c_{i,j} in the matrix is the coefficient correlation between the i^{th} and j^{th} signal. The values in the correlation matrix range from −1 to 1 where 1 indicates a perfect positive correlation: as one signal changes, the other changes proportionally. The correlation value computed between the same signal is always 1, as reflected in the diagonal of the matrix in FIG. 14. A correlation value of 0 implies that there is no correlation between the signals. A correlation value of −1 indicates a perfect negative correlation: where if one signal increases, the other decreases proportionally and vice versa. As the time series data in this study doesn't follow a normal distribution, Spearman's method has been utilized to calculate the correlation values using a MATLAB script. To enhance visualization, a colormap is provided in FIG. 14, where a shift towards red indicates a higher correlation between the corresponding signals. For example, the correlation between sample 2 and 3 of the 25% extrusion group is 0.88, implying a high correlation between them. Conversely, if two signals have little to no correlation, the corresponding block approaches blue color. For example, the sample 1 from 25% extrusion group and the sample 1 from 75% extrusion group shows a correlation value of 0.21, suggesting there is very little correlation between the signals.

While interpreting the correlation matrix for G-code modified samples in FIG. 14, first it can be observed that the samples within each group showed high correlation values among themselves except the samples of 75% extrusion. Secondly, the samples having 25% and 50% extrusion values show high correlation values among themselves, indicating they need another form of analysis to differentiate between them. Additionally, one sample from 75% extrusion showed a relatively high correlation with samples from 50% and 100% extrusion which further proves the argument that a correlation matrix alone can't be used to differentiate between groups of samples having different levels of underextrusion.

### Feature Extraction for G-Code Modified Samples

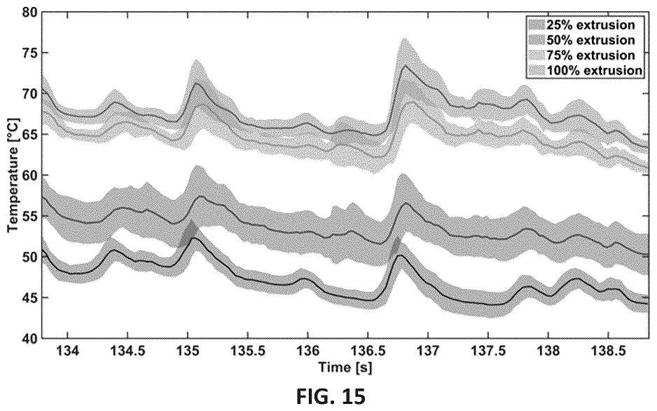

To classify among different groups of G-code modified samples, first, the sample size for each group is selected to be 10. The samples are printed in a random sequence to avoid any potential bias in the data acquisition process. The temperature information acquired for these samples is filtered in the same way as described herein, and the 5 seconds of initial data was extracted for further analysis. In FIG. 15, the general characteristics of the temperature profile for G-code modified groups has been plotted. The solid lines indicate the mean (p), and the shaded bands indicate the standard deviation (a) of the samples of each group. To examine whether the groups can be differentiated using threshold values between temporal features of different groups, two temporal features of each sample: the maximum and minimum of the temperature signals are calculated. As the data acquisition was performed at 30 Hz, the available frequency spectra are very limited, and thus, the frequency domain features are not considered in this approach.

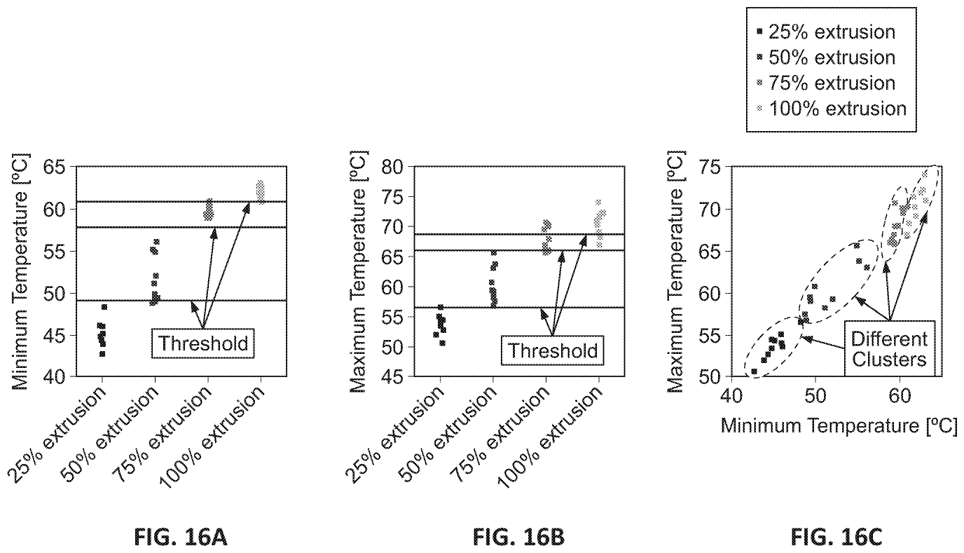

It is observed from FIGS. 16A and 16B, by placing a threshold between extracted features of all samples between G-code modified sample groups, it is easily possible to distinguish between extrusion levels of 25% and 100%. However, this gets considerably harder to differentiate between extrusion levels of 75% and 100%, as the different sample values can't be confined by placing any predefined threshold anymore. This implies the threshold strategy isn't reliable enough to differentiate between two close extrusion levels. Therefore, an alternative approach to solve this classification problem is adopted. Herein, two time-domain features, maximum and minimum temperature, have been utilized to plot the feature vs feature graphs. Here, the time domain features are plotted against each other as illustrated in FIG. 16C. By doing this, the features from various extrusion levels form different clusters. The measured features from a newly printed part fall into one of these clusters, which is utilized to identify the extrusion level of that part. This strategy can be extended to multiple features, and supervised classification algorithms can be employed to classify a newly printed sample. However, the use of machine learning algorithms on multi-dimensional feature data is beyond the scope of the current study. The findings demonstrate that the application of the proposed framework facilitates the establishment of a real-time, in-situ process monitoring system, proficient in categorizing varying levels of extrusion.

### CONCLUSION

Described herein is an infrared (IR) thermography-based framework for continuous data acquisition and processing, demonstrating its ability to distinguish between various levels of defects, including underextrusion defects, in ME. To avoid interruptions during printing, a prototype platform to integrate an IR camera is described and utilized for thermal data acquisition. Signal processing techniques are employed to automate the preprocessing of data, including normalization and artifact removal. The methods for categorizing between extrusion levels of 25%, 50%, 75%, and 100% are described in detail. It has been demonstrated that although the correlation matrix can hardly distinguish between samples of different groups, it is possible to classify the samples by extracting features from thermal signatures captured within 5 seconds of process deviation. The described embodiments provide for integration of infrared thermography into a robust real-time condition monitoring and control system capable of producing first-time-ready products.

It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

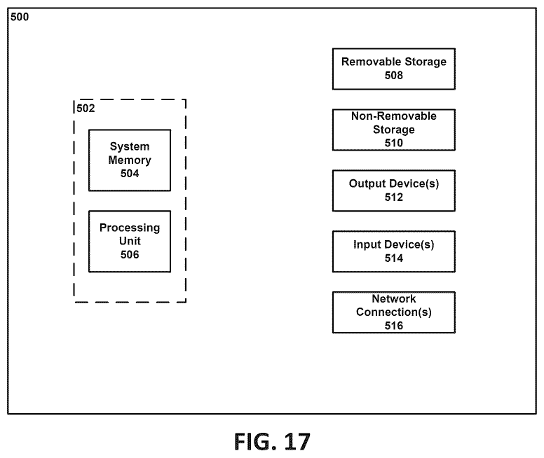

When the logical operations described herein are implemented in software, the process may execute on any type of computing architecture or platform. For example, referring to FIG. 17, an example computing device upon which embodiments of the invention may be implemented is illustrated. The computing device 500 may include a bus or other communication mechanism for communicating information among various components of the computing device 500. In its most basic configuration, computing device 500 typically includes at least one processing unit 506 and system memory 504. Depending on the exact configuration and type of computing device, system memory 504 may be volatile (such as random access memory (RAM)), non-volatile (such as read-only memory (ROM), flash memory, etc.), or some combination of the two. This most basic configuration is illustrated in FIG. 17 by dashed line 502. The processing unit 506 may be a standard programmable processor that performs arithmetic and logic operations necessary for operation of the computing device 500. As used herein, “processor” refers to a physical hardware device that executes encoded instructions for performing functions on inputs and creating outputs.

Computing device 500 may have additional features/functionality. For example, computing device 500 may include additional storage such as removable storage 508 and non-removable storage 510 including, but not limited to, magnetic or optical disks or tapes. Computing device 500 may also contain network connection(s) 516 that allow the device to communicate with other devices. Computing device 500 may also have input device(s) 514 such as a keyboard, mouse, touch screen, etc. Output device(s) 512 such as a display, speakers, printer, etc. may also be included. The additional devices may be connected to the bus in order to facilitate communication of data among the components of the computing device 500. All these devices are well known in the art and need not be discussed at length here.

The processing unit 506 may be configured to execute program code encoded in tangible, computer-readable media. Computer-readable media refers to any media that is capable of providing data that causes the computing device 500 (i.e., a machine) to operate in a particular fashion. Various computer-readable media may be utilized to provide instructions to the processing unit 506 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 506 may execute program code stored in the system memory 504. For example, the bus may carry data to the system memory 504, from which the processing unit 506 receives and executes instructions. The data received by the system memory 504 may optionally be stored on the removable storage 508 or the non-removable storage 510 before or after execution by the processing unit 506.

Computing device 500 typically includes a variety of computer-readable media. Computer-readable media can be any available media that can be accessed by device 500 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain. These publications incorporated by reference include, but are not limited to:
1. Madhavadas, V., et al., A review on metal additive manufacturing for intricately shaped aerospace components. CIRP Journal of Manufacturing Science and Technology, 2022. 39: p. 18-36.
2. Salifu, S., et al., Recent development in the additive manufacturing of polymer-based composites for automotive structures—A review. The International Journal of Advanced Manufacturing Technology, 2022. 119(11-12): p. 6877-6891.
3. Salmi, M., Additive manufacturing processes in medical applications. Materials, 2021. 14(1): p. 191.
4. Bhargav, A., et al., Applications of additive manufacturing in dentistry: A review. Journal of Biomedical Materials Research Part B: Applied Biomaterials, 2018. 106(5): p. 2058-2064.
5. Paolini, A., S. Kollmannsberger, and E. Rank, Additive manufacturing in construction: A review on processes, applications, and digital planning methods. Additive manufacturing, 2019. 30: p. 100894.
6. Bruère, V., et al., Under-extrusion challenges for elastic filaments: The influence of moisture on additive manufacturing. Progress in Additive Manufacturing, 2022. 7(3): p. 445-452.
7. He, K., Q. Zhang, and Y. Hong, Profile monitoring based quality control method for fused deposition modeling process. Journal of Intelligent Manufacturing, 2019. 30(2): p. 947-958.
8. Kutzer, M. D., L. D. DeVries, and C. D. Blas. Part monitoring and quality assessment of conformal additive manufacturing using image reconstruction. in International Design Engineering Technical Conferences and Computers and Information in Engineering Conference. 2018. American Society of Mechanical Engineers.
9. Fastowicz, J. and K. Okarma. Fast quality assessment of 3D printed surfaces based on structural similarity of image regions. in 2018 International Interdisciplinary PhD Workshop (IIPhDW). 2018.
10. Holzmond, O. and X. Li, In situ real time defect detection of 3D printed parts. Additive Manufacturing, 2017. 17: p. 135-142.
11. Baumann, F. W. and D. Roller. Vision based error detection for 3D printing processes. 2016.
12. Jin, Z., et al., Monitoring Anomalies in 3D Bioprinting with Deep Neural Networks. ACS Biomaterials Science & Engineering, 2023. 9(7): p. 3945-3952.
13. Hossain, M. S. and H. Taheri, In situ process monitoring for additive manufacturing through acoustic techniques. Journal of Materials Engineering and Performance, 2020. 29(10): p. 6249-6262.
14. Wu, H., Z. Yu, and Y. Wang, Real-time FDM machine condition monitoring and diagnosis based on acoustic emission and hidden semi-Markov model. The International Journal of Advanced Manufacturing Technology, 2017. 90(5): p. 2027-2036.
15. Shevchik, S. A., et al., Acoustic emission for in situ quality monitoring in additive manufacturing using spectral convolutional neural networks. Additive Manufacturing, 2018. 21: p. 598-604.
16. Wu, D., Y. Wei, and J. Terpenny, Predictive modelling of surface roughness infused deposition modelling using data fusion. International Journal of Production Research, 2019. 57(12): p. 3992-4006.
17. Kumar, S., et al., A low-cost multi-sensor data acquisition system for fault detection infused deposition modelling. Sensors, 2022. 22(2): p. 517.
18. Tlegenov, Y., W. F. Lu, and G. S. Hong, A dynamic model for current-based nozzle condition monitoring infused deposition modelling. Progress in Additive Manufacturing, 2019. 4: p. 211-223.
19. Esfahani, M. N., et al., In-situ layer-wise certification for direct laser deposition processes based on thermal image series analysis. Journal of Manufacturing Processes, 2022. 75: p. 895-902.
20. Baumgartl, H., et al., A deep learning-based model for defect detection in laser-powder bed fusion using in-situ thermographic monitoring. Progress in Additive Manufacturing, 2020. 5(3): p. 277-285.
21. Khanzadeh, M., et al., Dual process monitoring of metal-based additive manufacturing using tensor decomposition of thermal image streams. Additive Manufacturing, 2018. 23: p. 443-456.
22. Caltanissetta, F., et al., In-situ monitoring of Material Extrusion processes via thermal videoimaging with application to Big Area Additive Manufacturing (BAAM). Additive Manufacturing, 2022. 58: p. 102995.
23. Lewis, J. and A. L. Moore, In situ infrared temperature sensing for real-time defect detection in additive manufacturing. Additive Manufacturing, 2021. 47: p. 102328.
24. Paul, A., et al. A real-time iterative machine learning approach for temperature profile prediction in additive manufacturing processes. in 2019 IEEE International Conference on Data Science and Advanced Analytics (DSAA). 2019. IEEE.
25. Fathizadan, S., et al., A novel real-time thermal analysis and layer time control framework for large-scale additive manufacturing. Journal of Manufacturing Science and Engineering, 2021. 143(1).
26. Moskovchenko, A. I., et al., Characterizing depth of defects with low size/depth aspect ratio and low thermal reflection by using pulsed IR thermography. Materials, 2021. 14(8): p. 1886.
27. Liao, S., et al., Hybrid thermal modeling of additive manufacturing processes using physics-informed neural networks for temperature prediction and parameter identification. Computational Mechanics, 2023: p. 1-14.
28. Zeiser, A., et al., A data-centric approach to anomaly detection in layer-based additive manufacturing. at—Automatisierungstechnik, 2023. 71(1): p. 81-89.
29. Forster, R., et al. In-line monitoring of the fused filament fabrication additive manufacturing process. in Nondestructive Characterization and Monitoring of Advanced Materials, Aerospace, Civil Infrastructure, and Transportation XVII. 2023. SPIE.
30. AbouelNour, Y. and N. Gupta, Assisted defect detection by in-process monitoring of additive manufacturing using optical imaging and infrared thermography. Additive Manufacturing, 2023. 67: p. 103483.
31. Fu, Y., et al., Real-time structural validation for material extrusion additive manufacturing. Additive Manufacturing, 2023. 65: p. 103409.
32. Seppala, J. E., et al., Weld formation during material extrusion additive manufacturing. Soft matter, 2017. 13(38): p. 6761-6769.
33. Coogan, T. J. and D. O. Kazmer, Prediction of interlayer strength in material extrusion additive manufacturing. Additive Manufacturing, 2020. 35: p. 101368.
34. Ferraris, E., J. Zhang, and B. Van Hooreweder, Thermography based in-process monitoring of Fused Filament Fabrication of polymeric parts. CIRP Annals, 2019. 68(1): p. 213-216.
35. Dinwiddie, R. B., L. J. Love, and J. C. Rowe. Real-time process monitoring and temperature mapping of a 3D polymer printing process. in Thermosense: Thermal Infrared Applications XXXV. 2013. SPIE.
36. Malekipour, E., S. Attoye, and H. El-Mounayri, Investigation of layer based thermal behavior in fused deposition modeling process by infrared thermography. Procedia Manufacturing, 2018. 26: p. 1014-1022.
37. Bacciaglia, A. and A. Ceruti, Efficient toolpath planning for collaborative material extrusion machines. Rapid Prototyping Journal, 2023. 29(9): p. 1814-1828.
38. Morgan, R. V., et al., Emissivity measurements of additively manufactured materials. 2017, Los Alamos National Lab. (LANL), Los Alamos, NM (United States).
39. Wissler, C., The Spearman correlation formula. Science, 1905. 22(558): p. 309-311.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed:

1. A system for real-time in-situ detection and remediation of potential defects during an additive manufacturing (AM) process, comprising:
an AM system comprising as least an extrusion nozzle, a build plate on which a workpiece is developed by the AM system, a mechanical control system for the extrusion nozzle to control its location on and/or over the build plate, and a controller having at least an AM processor and an AM memory, wherein the AM processor executes computer-readable instructions stored on the AM memory to control the AM system including the mechanical control system and the extrusion nozzle, and wherein a material is extruded onto the build plate by the extrusion nozzle to develop the workpiece;
an infrared (IR) camera, wherein the IR camera continually acquires sequence IR images of the workpiece during the AM process without interrupting the extrusion process;
a computing device comprising at least a processor and a memory, wherein the processor execute computer-readable instructions stored in the memory to:
receive the IR images of the workpiece as they are acquired by the IR camera;
preprocess the acquired IR video images;
provide the preprocessed IR images to a deep learning model, wherein the deep learning model is trained to analyze the preprocessed IR images and make a prediction about a relative flow rate (RFR) of the material that is extruded onto the build plate by the extrusion nozzle; and
wherein the prediction of RFR is provided to the controller of the AM system during the workpiece development process and adjustments are made to the AM process, if needed, based on the predicted RFR to avoid potential defects, mitigate defects in process, and/or correct defects of the workpiece without interrupting the extrusion process.

2. The system of claim 1, wherein the AM process comprises a material extrusion (ME) process.

3. The system of claim 1, further comprising an extended platform attached to the AM system, wherein the IR camera is mounted on the extended platform.

4. The system of claim 1, wherein preprocessing the acquired IR images comprises one or more of image cropping, automation of extrusion start and end detection, start of predefined layer detection, sequence trimming, data labeling, data splitting, and data sub-segmentation.

5. The system of claim 4, wherein one or more of the preprocessing steps occur during data acquisition by the IR cameras, and one or more of these steps occur before feeding the acquired IR images into the deep learning model.

6. The system of claim 1, wherein the deep learning model comprises one of a convolutional neural networks (CNN), a CNN+long short-term memory (LSTM), a CNN+SelfAttention, or a recurrent neural networks (RNN).

7. The system of claim 6, wherein the deep learning model comprises the CNN+SelfAttention.

8. The system of claim 1, wherein the deep learning model is trained using datasets of thermal images correlated with process parameters and outcomes to identify patterns and anomalies that are indicative of process deviations, defects, or equipment malfunctions.

9. The system of claim 8, wherein the thermal images are preprocessed prior to training the deep learning model, said preprocessing comprising one or more of image cropping, automation of extrusion start and end detection, start of predefined layer detection, sequence trimming, data labeling, data splitting, and data sub-segmentation.

10. A method for real-time in-situ detection and remediation of potential defects during an additive manufacturing (AM) process, comprising:
acquiring infrared (IR) images of a workpiece during an additive manufacturing (AM) process;
preprocessing the acquired IR images;
analyzing the preprocessed IR images and make a prediction about a relative flow rate (RFR) of a material that is extruded onto a build plate by an extrusion nozzle during the AM process using a deep learning model; and
adjusting the AM process, if needed, based on the predicted RFR to avoid potential defects, mitigate defects in process, and/or correct defects of the workpiece.

11. The method of claim 10, wherein the AM process is performed by an AM system comprising as least the extrusion nozzle, the build plate on which a workpiece is developed by the AM system, a mechanical control system for the extrusion nozzle to control its location on and/or over the build plate, and a controller having at least an AM processor and an AM memory, wherein the AM processor executes computer-readable instructions stored on the AM memory to control the AM system including the mechanical control system and the extrusion nozzle, and wherein the material is extruded onto the build plate by the extrusion nozzle to develop the workpiece.

12. The method of claim 10, wherein an infrared (IR) camera acquires the IR images of the workpiece during the AM process.

13. The method of claim 12, wherein the AM system further comprises an extended platform, wherein the IR camera is mounted on the extended platform.

14. The method of claim 12, wherein preprocessing the acquired IR images comprises one or more of image cropping, automation of extrusion start and end detection, start of predefined layer detection, sequence trimming, data labeling, data splitting, and data sub-segmentation.

15. The method of claim 14, wherein one or more of the preprocessing steps occur during data acquisition by the IR camera, and one or more of these steps occur before feeding the acquired images into the deep learning model.

16. The method of claim 10, wherein the AM process comprises a material extrusion (ME) process.

17. The method of claim 10, wherein the deep learning model comprises one of a convolutional neural networks (CNN), a CNN+long short-term memory (LSTM), a CNN+SelfAttention, or a recurrent neural networks (RNN).

18. The method of claim 17, wherein the deep learning model comprises the CNN+SelfAttention.

19. The method of claim 10, wherein the deep learning model is trained using datasets of thermal images correlated with process parameters and outcomes to identify patterns and anomalies that are indicative of process deviations, defects, or equipment malfunctions.

20. The method of claim 19, wherein the thermal images are preprocessed prior to training the deep learning model, said preprocessing comprising one or more of image cropping, automation of extrusion start and end detection, start of predefined layer detection, sequence trimming, data labeling, data splitting, and data sub-segmentation.
